(19) United States
(12) Patent Application Publication
(10) Pub. No.: US 2013/0189548 A1
(43) Pub. Date: Jul. 25, 2013

(54) Secondary cell and method of operating same

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 13/734,601

(22) Filed: Jan. 4, 2013

Related U.S. Application Data
(60) Provisional application No. 61/582,834, filed on Jan. 4, 2012.

(30) Foreign Application Priority Data
Jan. 4, 2012 (DE) 10 2012 000 099.5

(51) Int. Cl. H01M 2/34

(52) U.S. Cl. CPC H01M 2/34
USPC 429/7; 429/61; 429/50

(57) ABSTRACT

A secondary cell (1) comprising a rechargeable electrode assembly (2) provided to at least intermittently supply electrical energy and which comprises at least two electrodes (2a, 2b) of different polarity and a separator arranged between said electrodes. The secondary cell (1) further comprises at least one current conduction device (3) provided to supply electrical energy from the electrode assembly (2) to an electrical load and which is electroconductively connected to said electrode assembly (2). The secondary cell (1) moreover comprises at least one measuring device (6) to detect an operating state, particularly an operating state of the electrode assembly (2), and a safety apparatus (8) to reduce a conduction cross section of the current conduction device (3) and thus effect a state of safety when the measuring device (6) detects a malfunction state which deviates from a normal operating state.

The present invention relates to a rechargeable electrochemical energy storage cell, hereinafter referred to as a secondary cell, for a battery and a method of operating such a secondary cell. The invention is described in conjunction with lithium ion batteries for supplying electric motors in motor vehicle drives. It is noted that the invention can also be used independent of the type of secondary cell and/or battery and independent of the type of drive supplied and/or the field of application.

Batteries with multiple secondary cells for supplying electrical loads, in particular vehicle drives, are known in the prior art. The secondary cells respectively comprise a casing, an electrode assembly for providing electrical energy and at least two current conduction devices. At least a part of the current conduction devices extend out of the casing in the proximity of the secondary cell and/or are accessible from the surroundings by way of the casing. The electrode assemblies and current conduction device are electroconductively interconnected within the casing. At least one electrical load can be electrically connected outside of the casing by way of the current conduction devices, thus closing an electric circuit to supply the load.

Thermal and mechanical loads as well as intrusions, particularly of electrically conductive fluids, can endanger the integrity of a secondary cell. This can thus create risk for the surroundings of the secondary cell.

It is an object of the invention to provide a secondary cell of increased safety.

This object is accomplished by a secondary cell having the features of claim 1 and a method for operating a secondary cell having the features of claim 9. Particularly preferred further developments of the invention constitute the subject matter of the subclaims.

The secondary cell according to the invention comprises a rechargeable electrode assembly which is provided to at least intermittently provide electrical energy and which comprises at least two electrodes of different polarity and a separator arranged between the electrodes. The secondary cell further comprises at least one, usually two, current conduction devices to provide electrical energy from the electrode assembly to an electrical load and which is/are electro-conductively connected to the electrode assembly. The inventive secondary cell additionally comprises: at least one measuring device for detecting an operating state, in particular an operating state of the electrode assembly, and a safety apparatus provided to reduce a conduction cross section of the current conduction device and thus effect a state of safety when the measuring device detects a malfunction state deviating from a normal operating state.

The current conduction device exhibits a specific conduction cross section in the secondary cell's normal operating state. The safety apparatus is designed to reduce this conduction cross section of the current conduction device when the at least one measuring device detects a malfunction state of the secondary cell which deviates from a normal operating state.

A transition into the safety state in which the conduction cross section of the current conduction device is reduced is initiated in the inventive secondary cell upon an unsafe and/or uncertain state of the secondary cell and/or its surroundings being determined, in particular on the basis of the value of at least one operating parameter. Reducing the conduction cross section reduces the flow of current to the electrical load. Only a limited exchange of energy with the secondary cell's electrode assembly is then possible. This thus lowers the potential risk emanating from the electric circuit supplied by the secondary cell, particularly due to an uncontrolled exchange of energy with the secondary cell's electrode assembly.

The secondary cell is preferably configured to be brought into the safety state by the safety apparatus when the temperature in the secondary cell exceeds 70° C., 80°° C., 90° C., 100° C. or 110° C. and/or when the secondary cell's ratio of internal pressure to ambient pressure exceeds 1.1, 1.2, 1.5, 1.7, 2, 5 or 10.

An electrode assembly within the meaning of the invention refers to a device which serves in particular in supplying electrical energy. To this end, the electrode assembly comprises at least two electrodes of differing polarity, wherein the electrodes are spaced apart by a separator. The electrode assembly is dischargeable and rechargeable, wherein electrolyte ions diffuse through the separator during the charge/discharge process. When the secondary cell is being charged, the electrical energy of the charging current is converted into chemical energy in the electrode assembly. When being discharged, the chemical energy is converted back into electrical energy and an electron flow generated which can in particular electrically supply a load.

An electrode particularly comprises a metal collector film. An active electrode mass is deposited on the collector film. One area of the collector film preferably remains free of the active electrode mass. The collector film preferably comprises copper and/or aluminum material.

In accordance with the invention, it is preferable to use a separator which does not at all or only poorly conducts electrons, and which comprises a substrate at least partially permeable to substances. The substrate is preferably coated with an inorganic material on at least one side. An organic material formed as non-woven material is preferably used as the at least partially permeable substrate. The organic material, which preferably comprises a polymer and particularly preferentially a polyethylene terephthalate (PET), is coated with an inorganic, preferably ion-conducting material which is preferably conductive to ions within a temperature range of −40° C. to 200° C. The inorganic material preferentially comprises at least one compound from among the group of oxides, phosphates, sulfates, titanates, silicates and aluminosilicates having at least one of the elements Zr, Al and Li, particularly preferably zircon oxide. It is preferred for the inorganic, ion-conducting material to have particles no larger than 100 nm in diameter. Such a separator is in particular marketed in Germany by Evonik AG under the trade name of “Separion.”

The electrode assembly of the secondary cell is preferably at least partially enclosed by a casing. A casing in the sense of the invention particularly refers to a device which at least partially encloses the secondary cell and delimits the secondary cell from its environment. The casing is preferably of dimensionally stable design so as to provide a stable structure and serve in mechanically accommodating the components of the secondary cell and/or the fixed arrangement of the secondary cell within an inclusive battery. The casing is particularly preferentially configured from a metal, preferably aluminum, copper, iron and/or alloys thereof. The casing is preferably of foil-like design so as to provide an at least partially adaptive mechanical structure in which components of the secondary cell are situated. This embodiment provides the advantage of protecting the components of the secondary cell from environmental influences, particularly mechanical load, thermal load, fluids and/or liquids. The casing is preferably configured with at least one polymer layer and one metal layer.

The secondary cell according to the invention preferably comprises lithium ions. This embodiment provides the advantage of a higher energy density to the secondary cell, in particular an energy density of at least 40 Wh/kg.

To be understood by a current conduction device in the sense of the invention is a device for providing an electrical connection between an electrode of the electrode assembly and an electrical load connection so that a current conduction device can close a respective electric circuit by a connection between the positive electrode and the electrical load and a connection between the negative electrode and the load. The current conduction device in particular comprises a conductor tab which is particularly integrally connected to the collector film. The conductor tab preferably extends beyond a separator adjacent the electrode. It is preferential for the current conduction device to comprise a current conductor which in particular partially protrudes from the casing and/or an electrical input lead connected in particular to the electrical load or to a device serving to connect the input lead to the load, particularly a plug connector.

A normal operating state in the sense of the invention refers to a state of the secondary cell in which the integrity of the secondary cell is not endangered, particularly by external influences. In particular, there is no exchange of substances with the environment in the normal operating state. A normal operating state preferably refers to a state of the secondary cell in which an operating parameter is within a predetermined, particularly appropriate operating parameter interval. A normal operating state can in particular be a state in which an operating parameter is shorter than during a predetermined time interval outside the limits of a predetermined operating parameter interval. Preferably, the normal operating state denotes a state in which the secondary cell is used to supply energy to an electrical load, hereinafter referred to as the supply state, or is being charged by an energy source, hereinafter referred to as the charge state. The normal operating state preferably further denotes a state in which the secondary cell can be brought into a supply state and/or a state of charge.

A malfunction state in the sense of the present invention refers to a state deviating from the secondary cell's normal operating state. Within the meaning of the invention, deviating is to be particularly understood as states not being identical to a predefined criterion. In particular, a malfunction state can be understood as a state of the secondary cell in which the at least one operating parameter is not within a predetermined operating parameter interval, particularly longer than during a predetermined time interval.

An operating parameter in the sense of the invention is particularly to be understood as a time-dependent variable which can be measured preferably by a sensor, in particular indirectly and/or directly, or a variable, the value of which can be determined by a processing unit, in particular by deductive and/or inductive causal inference. An operating parameter particularly refers to an amperage, a voltage, a temperature, a time interval, a pressure, a pH value, a position and/or their temporal derivatives. Composite parameters, in particular based on mathematical-logical functions, further constitute operating parameters. Secondary cell parameters preferably constitute operating parameters.

An operating parameter interval in the sense of the invention refers to a set of values which an operating parameter may assume in order to ensure proper operation of the secondary cell. The operating parameter interval can in particular be defined as a left-unbounded interval [- ∞, p] or a right-unbounded interval [p, ∞] if only one parameter limit p is given. In this case, a departure from the operating parameter interval is assumed should the limit value p be exceeded (left-unbounded interval) or should the limit value p be undershot (right-unbounded interval). In one preferred embodiment, the operating parameter interval is defined by a complementary exclusion interval. An operating parameter then accordingly departs from the operating parameter interval when it is within the exclusion interval.

A safety state in the sense of the present invention refers to an operating state of the secondary cell in which the safety apparatus reduces the conduction cross section of the current conduction device.

In accordance with the invention, the secondary cell comprises a measuring device for detecting at least one operating state. The measuring device in particular has at least one sensor which can particularly detect one of the above-defined operating parameters. The measuring device preferably comprises a computing unit in which the measured signals can be mathematically-logically processed in a predefined manner. The measuring device furthermore comprises an output unit, an analog and/or digital interface in particular, able to furnish the measured signals, the processed measured signals and/or information on the measured signals. A memory unit is preferably allocated to the measuring device which in particular stores at least one operating parameter interval. The measuring device is preferentially integrated into the secondary cell and/or disposed adjacent to same. Doing so particularly allows realizing a compact construction and/or simplifies the maintenance of the secondary cell including its cell control device.

In accordance with the invention, the secondary cell comprises a safety apparatus. Said safety apparatus is configured to induce a safety state for the secondary cell by reducing the conduction cross section of the current conduction device. Said reduction leads to an increase in the electrical resistance of the current conduction device. The safety apparatus is in particular configured to effect a decrease in the conduction cross section to a value of between at least 0.01, 0.05, 0.1 or 0.2 and/or a maximum of 0.1, 0.2, 0.4 or 0.8 of the initial conduction cross section. The safety apparatus preferably effects a reducing of the conduction cross section to zero so as to interrupt the electrical load circuit and the secondary cell no longer being able to supply energy to the electrical load. The safety apparatus can in particular be activated and/or triggered by command from a control device, the cell control device in particular.

In one preferred embodiment of the invention, the measuring device detects a malfunction state of the secondary cell should an operating parameter, a secondary cell operating parameter in particular, be longer than during a predetermined time interval outside the limits of a predetermined operating parameter interval.

Preferably, a transition of the secondary cell into the safety state can be readied, but not yet triggered, when an operating parameter is not within the predetermined operating parameter interval during a predetermined time interval and can in particular be triggered under the condition that the operating parameter is outside the limits of the operating interval over a predetermined time interval.

According to a preferred further development, a cell control device is allocated to the secondary cell which is configured to initiate a secondary cell state transition. The cell control device is preferably configured to process at least one measured value. Such a measured value can in particular represent either an operating parameter of the secondary cell or its environment and/or a mathematical-logical operation based on at least one such operating parameter. An operating parameter of the secondary cell environment can in particular be an operating parameter of a battery comprising said secondary cell. The cell control device is preferably integrated into the secondary cell and/or disposed adjacent to same. Doing so particularly allows realizing a compact construction and/or simplifies the maintenance of the secondary cell including its cell control device. The cell control device is preferably integrally formed with a control device of an inclusive battery or motor vehicle.

In one preferred embodiment of the invention, the secondary cell comprises a cell control device which is configured to process a measured value, in particular to process a measured value representative of an operating parameter of said secondary cell; and/or to process a measured value which represents an operating parameter of an environment of the secondary cell, preferably of an inclusive electrical load and/or an electrical load to be supplied.

In a further preferred embodiment of the invention, the safety apparatus comprises a pyrotechnic device which serves at least indirectly in reducing the conduction cross section of the current conduction device. Detonation of an explosive charge can in particular effect an activating of the safety apparatus. Doing so thus exerts mechanical forces on the current conduction device, particularly on components of the current conduction device, such that the mechanical forces can in particular fragment and/or break off components of the current conduction device and thereby at least partially reduce the electrically conductive cross section of the current conduction device. The safety apparatus preferably comprises a pin which is driven against the current conduction device by the detonating of a pyrotechnic explosive charge and reduces, particularly separates, the conduction cross section of the current conduction device by mechanical action. A pyrotechnic safety apparatus particularly maximizes the speed of transition into the safety state.

In a further preferred embodiment of the invention, the safety apparatus comprises a temperature-increasing device which in particular effects a melting so as to cause a reduction in the conduction cross section of the current conduction device. Doing so in particular enables components of the current conduction device to thoroughly melt or melt away so as to effect a break in the electric circuit at the heated regions and thereby reduce the electrically conductive cross section of the current conduction device. Preferably, the safety apparatus effects a thermite reaction and/or an extreme exothermic chemical reaction of similar action to thereby generate the required temperature in order to melt away or thoroughly melt the current conductor at the intended location(s). In particular, a safety apparatus based on temperature increase advantageously provides high spatial control of the separation effect.

In a further preferred embodiment of the invention, the safety apparatus comprises a mechanical effector device which serves in reducing the conduction cross section of a current conduction device by means of selective mechanical deformation. Said deformation can preferably be an indenting effected by a safety apparatus preferentially effecting the selective mechanical change in the manner of a hammer. An actuator preferably comprises a movable edge or a movable pin which acts in particular on the current conduction device and at least partly displaces its material and thereby effects the reduction in the conduction cross section. In particular, such a safety apparatus advantageously provides high spatial control of the separation effect.

The safety apparatus preferably serves in the reducing of the conduction cross section of a current conductor of the secondary cell's current conduction device, at least indirectly.

In one preferred embodiment, the safety apparatus serves in reducing the conduction cross section by acting on at least one web and/or thin spot of the current conduction device. The current conduction device thereby comprises at least one web, particularly two or more webs, wherein a plurality of webs are spaced apart from one another particularly by at least one recess and/or thin spot. Webs represent electrically conductive areas of the current conduction device or its current conductor which are in particular configured so as to conduct current through the current conductor. Thin spots represent areas in which the current conduction device exhibits a reduced conduction cross section, particularly in line with its manufacture. Recesses are areas containing no current-conducting material, in particular no material at all.

A current conduction device structured by means of webs and recesses and/or thin spots exhibits a perforated and/or grid structure in particular. In the case of a perforated structure, the recesses and/or thin spots constitute the perforations, the perforation holes respectively, which are in particular spaced apart by webs. In the case of a grid structure, the stanchions constitute the webs and their interspaces the recesses. A perforated structure can in particular exhibit different recesses and webs of differing sizes. A grid structure can in particular furthermore exhibit different types of grids particularly having webs of different forms, orientation and/or size as well as recesses and/or thin spots of different forms, thicknesses and/or size. A grid structure in particular exhibits a cross-grid and/or a parallel grating.

The safety apparatus acts on the webs and/or the thin spots in order to bring the secondary cell into the safety state and reduce the conduction cross section. A combination of perforated structure and grid structure can preferably realize a material web on which the safety apparatus acts. The structuring of the current conduction device, components of the current conduction device respectively, particularly provides the advantage of being able to better control the conduction cross section in the second state, particularly when the structure and the safety apparatus are adapted to one another.

A perforated or grid structure is preferably limited to the current conductor, components of the current conductor respectively. In this case, the safety apparatus preferably acts solely on the current conductor and particularly on the respective components of the current conductor which are structured accordingly. Such a current conductor can in particular advantageously modularize the implementing of an inventive secondary cell in its manufacture.

In a further preferred embodiment of the invention, the secondary cell further comprises a discharge device which is configured to close an electric circuit, in particular after the transition to the safety state, in order to at least partially discharge the secondary cell and thus bring it into an advanced safety state. This electric circuit is preferably switched parallel to the electrical load circuit. Stored energy is withdrawn from the secondary cell over this electric circuit. This energy is preferably dissipated in a resistor, particularly in such a manner that a rise in temperature of the resistor will not exceed a predefined limit value of between at least −10° C., 0° C., 5° C., 10° C. and/or a maximum of 50° C., 60° C., 90° C. or 150° C. The discharge device preferably further brings the secondary cell into a predefined state of charge which particularly preferentially amounts to zero.

The discharge electric circuit is preferably protected by a diode circuit so that the secondary cell cannot be charged via this secondary cell electric circuit. In a preferred embodiment, the diode circuit consists of just one single diode. During the transition into the second state, at least one web and/or at least one thin spot preferably remains electrically conductive so that the electric circuit can thereby be closed in order to realize the discharging. It is particularly preferential for the remaining web and/or remaining thin spot to be provided with a diode, particularly to be realized as a diode. In one preferred embodiment, the discharge device is integrated into the secondary cell or disposed adjacent to same in order to particularly serve in simplifying maintenance and/or enabling a more compact construction.

A battery having at least two of the above-described inventive secondary cells is also an object of the invention. The battery can in particular be equipped with a control unit which is configured to communicate with one of the secondary cells and preferably activate a safety apparatus and/or a discharge apparatus. The battery is preferably provided with a housing which in particular comprises means for disposing and/or electrically interconnecting two or more secondary cells. The battery can in particular be provided to furnish electrical energy to an electrical load of a motor vehicle, particularly for mounting into a motor vehicle. The battery is furthermore preferably configured to supply a drive motor, a main drive motor in particular, to enable quick replacement and/or be disposed adjacent to other battery units, particularly to be mechanically connected to same.

A further object of the invention is a method for operating a secondary cell having a rechargeable electrode assembly which is provided to at least intermittently provide electrical energy and which comprises at least two electrodes of different polarity and a separator, wherein the separator is arranged between said electrodes, and at least one current conduction device which is provided to supply electrical energy from the electrode assembly to an electrical load and which is electro-conductively connected to the electrode assembly, particularly a secondary cell in accordance with the invention, comprising the steps of determining whether the secondary cell is in a malfunction state which deviates from a normal operating state; and reducing a conduction cross section of the current conduction device and thereby bring the secondary cell into the safety state when the secondary cell is in the malfunction state.

The advantages of this inventive method, the defined terminology and the preferential further developments correspond to those as indicated above in conjunction with the inventive secondary cell and will be omitted here for the sake of avoiding repetition.

In one preferred embodiment of the invention, after being transitioned into the safety state, an operating parameter is detected in a further method step, in particular the state of charge of the electrode assembly, in order to determine how high the remaining risk is for the secondary cell in the safety state. Commensurate with a result from this method step, a discharge device is then activated as needed, in particularly by a controller, preferably a cell control device. Doing so can then particularly close a further electric circuit leading over the discharge apparatus. An amount of charge, particularly one that is predefined, can then be withdrawn from the secondary cell in a further method step. Doing so leaves only a defined amount of charge remaining in the secondary cell. Said amount of charge is preferably zero. A predetermined amount of charge is preferably withdrawn from the secondary cell by the discharging and/or the secondary cell is discharged to a specific state of charge which in particular assumes a value of between at least 0.05, 0.1 or 0.2 and/or a maximum of 0.1, 0.2, 0.4 or 0.8 multiplied by the nominal charge or preferably zero.

Further advantages, features and application possibilities of the present invention will be evident from the following description coupled with the drawings, which show:

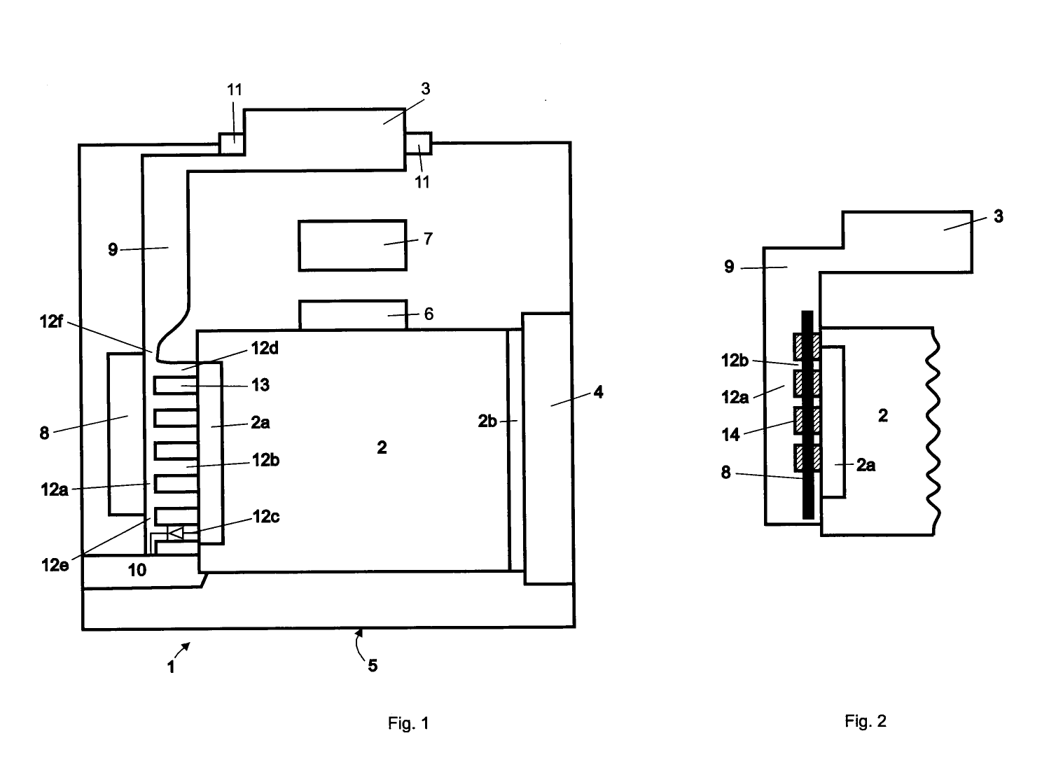

FIG. 1 a schematic depiction of the configuration of an inventive secondary cell in accordance with a preferred embodiment;

FIG. 2 a schematic detail of a secondary cell in accordance with a further preferred embodiment;

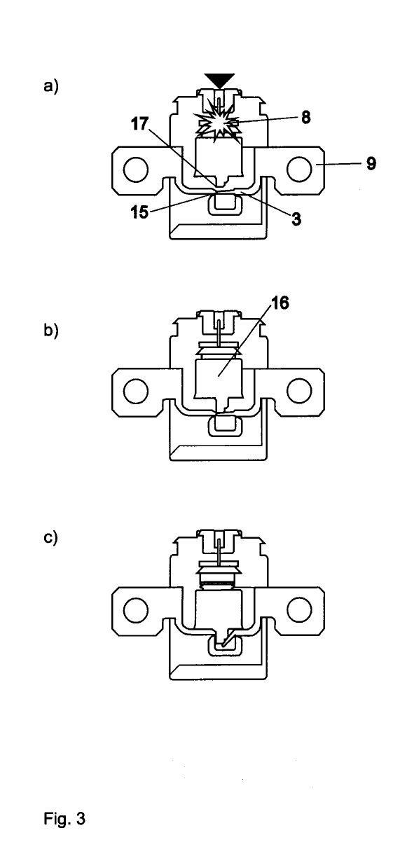

FIG. 3 schematic depictions of the configuration of a safety apparatus and how it acts on a component of a current conduction device in accordance with a preferred embodiment of the invention;

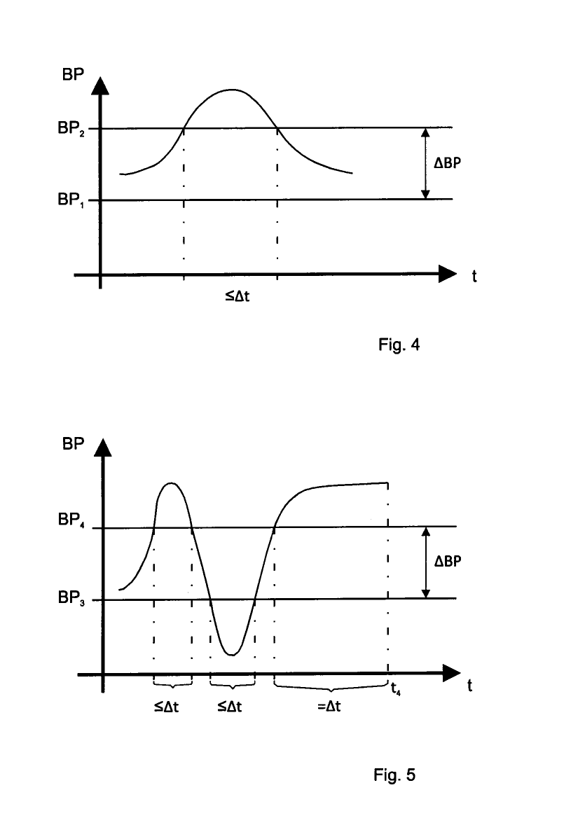

FIG. 4 a diagram to illustrate the predetermined time interval; and

FIG. 5 a further diagram to illustrate the predetermined time interval.

FIG. 1 schematically depicts an inventive secondary cell 1 in accordance with a preferred embodiment comprising an electrode assembly 2 and two current conduction devices 3 and 4, wherein each of the current conduction devices is respectively connected to one of the two electrodes 2a, 2b of the electrode assembly 2. The secondary cell further comprises a cell control device 7.

The electrode assembly 2 comprises a negative and a positive electrode 2a, 2b as well as a measuring device 6 for acquiring measurement values related to operating parameters. The left-side electrode 2a of the electrode assembly 2 is connected to a current conduction device 8 partially extending out of the casing 5 and protected from electrically contacting the casing by isolators 11 as well as a current conductor 9 connected to the electrode 2a. A further current conductor 4 connects the right-side electrode 2b of the electrode assembly 2 to the casing 5 so as to be electrically conductive, concurrently forming a further current conduction device.

The current conductor of the current conduction device 3 exhibits alternatingly arranged horizontal webs 12b and recesses 13 in the connecting area with the electrode 2a. The current conductor 9 is in electrical contact with the electrode 2a by means of the horizontal webs 12b. A vertical web 12a is respectively disposed between two horizontal webs 12b as well as above the uppermost horizontal web 12d. Current is fed to the electrical load via the vertical web 12a.

A safety apparatus 8 is disposed adjacent to the vertical webs 12a. Said safety apparatus 8 is configured so as to separate at least one of the vertical webs 12a and thereby effect a reducing of the conduction cross section, thus bringing the secondary cell into the safety state.

Separating the lowermost vertical web 12e in the region of the safety device 8 creates a minimum discrete reduction in the conduction cross section. Separating web 12f creates a maximum reduction in the conduction cross section, thereby reducing it to zero. Separating the middle vertical webs creates a reduction in the conduction cross section wherein the amount of reduction rises discretely with the height of the respective web arrangement. Separating the uppermost vertical web results in the electrode assembly 2 no longer being able to provide current via the current conduction device 3 since there is no electrical connection between the current conduction device 3 and the electrode assembly 2 via the left-side electrode 2a.

The lowermost web 12c of the current conductor 9 comprises a diode which fixes the direction of the current flow such that the electrode assembly 2 cannot be charged via this web 12c. A further electric circuit leading over the discharge device 10 between the two electrodes 2a, 2b of the electrode assembly 2 can be closed by way of this web.

The discharge device 10 is configured so as to be able to bring the secondary cell into an advanced safety state. Said discharge device 10 comprises a ballast resistor which dissipates the electrical energy stored in the electrode assembly 2. The discharge device 10 is activated by the cell control device 7. Not until the discharge device 10 is activated is an electric circuit over the discharge device closed and thus the electrode assembly 2 charging reduced.

If the safety apparatus 8 at least partially separates the uppermost vertical web 12f of the current conductor 9, the secondary cell 1 can only be discharged via the discharge device 10.

FIG. 2 schematically depicts a detail of an inventive secondary cell 1, as shown e.g. in FIG. 1, according to a further preferred embodiment.

The left-side electrode 2a is in electrical contact with a current conductor 9 exhibiting thin spots 14 in the lower region, whereby horizontal and vertical webs 12a, 12b are arranged around said thin spots 14. A safety apparatus 8 is disposed on the current conductor 9 on the thin spots 14 and the horizontal webs 12b. The safety apparatus 8 is configured so as to separate both the thin spots 14, individually in particular, as well as also the horizontal webs 12b in order to reduce the conduction cross section of the current conductor 9, the current conduction device 3 respectively.

When both the thin spots 14 as well as the horizontal webs 12b are separated, the conduction cross section is zero. This results in the electrode assembly 2 no longer being able to provide current via the current conduction device 3 since there is no electrical connection between the current conduction device 3 and the electrode assembly 2 via the left-side electrode 2a.

FIG. 3 schematically depicts the configuration and the mode of operation of a safety apparatus in accordance with a preferred embodiment.

The illustration shows an example of a circuit breaker from the Autoliv B.V. & Co. KG company in Germany, wherein its operational principle has been incorporated into a preferred embodiment of the inventive secondary cell. Depicted according hereto is a component of the current conduction device 3, a component of a current conductor 9 in particular, comprising a rated break point 15. The safety apparatus further comprises a separating apparatus 16 configured as a cylinder and provided with a sharp separator edge 17. The cylinder is configured so as to be driven against the break point of the current conduction device 3 by a pyrotechnic primer.

Sub-figure 3a depicts the state of the safety apparatus 8 and a component of the current conduction device 3 when the primer detonates. Sub-figure 3b depicts how the explosive charge drives the cylinder against the rated break point 15. Sub-figure 3c depicts how the separator edge 17 of the cylinder of the separating apparatus 16 separates the current conduction device 3 at the break point 15 and thus breaks an electric circuit closed by the current conduction device 3.

FIG. 4 is a graph illustrating the significance of the predetermined time interval At according to a preferred embodiment.

The graph shows the time t on the horizontal axis. The vertical axis represents an operating parameter BP. An operating parameter interval ΔBP for the depicted operating parameter BP is predefined between the BP₁ and BP₂ values; i.e. ΔBP=BP₂−BP₁. The secondary cell is in the normal operating state when the operating parameter BP is within the operating parameter interval ΔBP or at least does not remain outside of said operating parameter interval ABP for any longer than the duration of the predetermined time interval Δt.

The secondary cell can be transformed into the safety state when the operating parameter BP of the secondary cell lasts longer than the operating parameter interval ΔBP defined by the predetermined time interval Δt. Adherence to the time interval Δt is monitored in real time.

FIG. 5 illustrates the significance of the predetermined time interval Δt according to a preferred embodiment in a further graph.

The graph shows the time t on the horizontal axis. As in FIG. 4, the vertical axis represents an operating parameter BP. An operating parameter interval ΔBP for the depicted operating parameter BP is predefined between the BP₃ and BP₄ values; i.e. ΔBP=BP₄−BP₃.

Pursuant this embodiment, the secondary cell will not be brought into the safety state as long as the operating parameter BP does not depart from the operating interval for longer than the time interval Δt. This has the effect that a departure from the operating parameter interval ΔBP which is temporally irrelevant to the functioning of the secondary cell, particularly during which there is no malfunction state, will not result in initiating a transforming of the secondary cell into the safety state. The two first time intervals in the graph (on the left in the figure) are temporally irrelevant intervals having times values of ≦Δt. The third depicted interval (on the right in the figure) represents a departing from the operating parameter range ΔBP which is temporally relevant to the functioning of the secondary cell. As soon as the currently detected time period is greater than the predefined time interval Δt; i.e. point t4 in the present case, transformation of the secondary cell into the safety state is automatically initiated. Adherence to the time interval Δt is monitored in real time.

### REFERENCE NUMERALS

1 secondary cell
2 electrode assembly
2a, 2b electrodes
3, 4 current conduction device
5 casing
6 measuring device
7 cell control device
8 safety apparatus
9 current conductor
10 discharge device
11 isolator
12a vertical web
12b horizontal web
12c horizontal web protected by diode
12d uppermost horizontal web
12e lowermost vertical web in the region of the safety apparatus
12f uppermost vertical web
13 recess
14 thin spot
15 rated break point
16 separating apparatus
17 separator edge
BP operating parameter
ΔBP operating parameter interval
t time
Δt time interval

1. A secondary cell, comprising:
a rechargeable electrode assembly which is provided to at least intermittently provide electrical energy and which comprises at least two electrodes of different polarity and a separator, wherein the separator is arranged between said electrodes;
at least one current conduction device which is provided to supply electrical energy from the electrode assembly to an electrical load, and which is electroconductively connected to said electrode assembly;
at least one measuring device which is provided to detect an operating state, particularly an operating state of the electrode assembly; and
a safety apparatus which is provided to reduce a conduction cross section of the current conduction device and thus effect a state of safety when the measuring device detects a malfunction state deviating from a normal operating state.

2. The secondary cell according to claim 1,
wherein
the measuring device detects a malfunction state should an operating parameter (BP), be longer than during a predetermined time interval (Δt) outside the limits of a predetermined operating parameter interval (ΔBP).

3. The secondary cell according to claim 1,
comprising
a cell control device configured to
process a measured value and/or
process a measured value representing an operating parameter of the environment of the secondary cell (1).

4. The secondary cell according to claim 1,
wherein
the safety apparatus comprises:
a pyrotechnic device which serves at least indirectly in reducing the conduction cross section by mechanically acting on the current conduction device; and/or
a heat source which serves in raising the temperature of the current conduction device and thereby serves at least indirectly in reducing the conduction cross section; and/or
a mechanical effector device which at least indirectly effects a deformation of the current conduction device and thereby serves in reducing the conduction cross section.

5. The secondary cell according to claim 1,
wherein
the current conduction device comprises a current conductor connected to the electrode assembly and the safety apparatus is provided to at least indirectly reduce a conduction cross section of the current conductor.

6. The secondary cell according to claim 1,
wherein
the current conduction device comprises at least one web and/or at least one thin spot and the safety apparatus is provided to separate the at least one web and/or the at least one thin spot.

7. The secondary cell according to claim 1,
wherein
a discharge device which is configured to bring the secondary cell into an advanced safety state, wherein an electric circuit is closed in said advanced safety state in order to at least partially discharge the secondary cell.

8. A battery, comprising: at least two secondary cells in accordance with claim 1.

9. A method of operating a secondary cell having a rechargeable electrode assembly which is provided to at least intermittently supply electrical energy and which comprises at least two electrodes of different polarity and a separator, wherein the separator is arranged between said electrodes, and at least one current conduction device which is provided to supply electrical energy from the electrode assembly to an electrical load, and which is electroconductively connected to said electrode assembly, said method comprising:
determining whether the secondary cell is in a malfunction state which deviates from a normal operating state; and
reducing a conduction cross section of the current conduction device and thereby bringing the secondary cell into a safety state upon the secondary cell being in the malfunction state.

10. The method according to claim 9,
wherein
the malfunction state of the secondary cell is determined when an operating parameter (BP), is longer than during a predetermined time interval (Δt) outside the limits of a predetermined operating parameter interval (ΔBP).

11. The method according to claim 9,
wherein
a conduction cross section of the current conduction device is reduced by
a pyrotechnic device mechanically acting at least indirectly on the current conduction device; and/or
raising a temperature of the current conduction device; and/or
a mechanical effector device at least indirectly deforming the current conduction device.

12. The method according to claim 9,
wherein
following the transition into the safety state, the secondary cell is brought into an advanced safety state in which a particularly predetermined amount of charge is withdrawn from the secondary cell so that said secondary cell assumes a lower state of charge than in the normal operating state or in the malfunction state.

13. The secondary cell according to claim 1, wherein an operating state of the electrode assembly is detected.

14. The secondary cell according to claim 2, wherein the operating parameter is a secondary cell operating parameter.

15. The secondary cell according to claim 3, wherein a measured value is processed which is representative of an operating parameter of the secondary cell.

16. The secondary cell according to claim 3, wherein the measured value representing an operating parameter of the environment of the secondary cell is an inclusive electrical load and/or an electrical load to be supplied.

17. The secondary cell according to claim 7, wherein the electric circuit closed by the discharge device is protected by a diode circuit so as to alone enable a discharge of the secondary cell.

18. The battery according to claim 8, which is suitable for providing electrical energy for an electrical load of a motor vehicle.
